(19) United States
(12) Patent Application Publication
(10) Pub. No.: US 2014/0122185 A1
(43) Pub. Date: May 1, 2014

(54) SYSTEMS AND METHODS FOR ENGAGEMENT ANALYTICS FOR A BUSINESS

(71) Applicant: TATA CONSULTANCY SERVICES LIMITED, Mumbai (IN)

(72) Inventors: Veerendra Kumar RAI, Pune (IN); Sanjit MEHTA, Pune (IN); Niviesh JALLA, Anson (SG)

(73) Assignee: TATA CONSULTANCY SERVICES LIMITED, Mumbai (IN)

(21) Appl. No.: 14/056,380

(22) Filed: Oct. 17, 2013

(30) Foreign Application Priority Data
Oct. 31, 2012 (IN) 3167/MUM/2012

(51) Int. Cl. G06Q 10/06

(52) U.S. Cl. CPC G06Q 10/0637
USPC 705/7.36

(57) ABSTRACT

Described is a method for engagement analytics. The method includes identifying criteria, and sub-criteria of each of the criteria, associated with a plurality of engagements between a vendor and a client, and identifying influencor sub-criteria and influencee sub-criteria amongst the sub-criteria. First levels of influence of the influencor sub-criteria of each of the criteria with respect to the influencee sub-criteria of each of the criteria; second levels of influence of the plurality of engagements with respect to the sub-criteria of all the criteria; and third levels of influence of the sub-criteria of all the criteria with respect to the engagements, are estimated. Further, a selection order of the plurality of engagements is determined based on the first, the second and third levels of influence. The selection order has priority values indicative of a level of realization of each of the engagements for the selection of the at least one engagement.

### TECHNICAL FIELD

The present subject matter relates to engagement analytics for a business and, particularly but not exclusively, to a computer-implementable systems and methods for engagement analytics for selection of one or more business engagements for transformation.

### BACKGROUND

Businesses that are carried out for providing services, products, and such, are usually bound by business engagements in the form of contracts to meet business objectives. A business engagement may define how a business process should be carried out by the vendor for providing a service and/or a product to the client. Typically, each business engagement is governed by an operating model, based on which resources are managed, and is governed by a pricing model, based on which the client is charged by the vendor for the services and/or products.

In a business portfolio, one or more business engagements may be at varied levels of maturity and realization at any given point of time. The level of maturity of a business engagement defines how mature the business engagement is to meet the business objective and the level of realization of a business engagement is indicative of the level to which the client's expectations are realized based on the business objectives.

The level of realization for a business engagement can be enhanced by a transformation of the business engagement. The transformation of a business engagement refers to changes in the operating model and the pricing model, where the changes are outside the scope of the business engagement. Further, the transformation of a business engagement is cost and resource incurring and is a strategic decision taken in respect of the business objective. Even after the transformation, the business engagement may not be able to achieve a level of realization as desired by the client. Thus, it is important to identify methodologies to analyze business engagements for facilitating a selection of a business engagement that has a potential for achieving a level of realization, after the transformation, as desirable to the client.

### SUMMARY

This summary is provided to introduce concepts related to systems and methods for engagement analytics for a business for selection of one or more engagements for transformation. This summary is neither intended to identify essential features of the claimed subject matter nor is it intended for use in determining or limiting the scope of the claimed subject matter.

In accordance with an embodiment of the present subject matter, a method for engagement analytics for a business is described. The method for engagement analytics includes identifying criteria, and sub-criteria of each of the criteria, associated with a plurality of engagements between a vendor and a client. The plurality of engagements is based on a business objective. The method also includes identifying influencor sub-criteria and influencee sub-criteria amongst the sub-criteria of all the criteria, where each of the influencor sub-criteria has an influence, relevant for selection of at least one engagement, on at least one of the influencee sub-criteria. The method also includes estimating (a) first levels of influence comprising levels of influence of the influencor sub-criteria of each of the criteria with respect to the influencee sub-criteria of each of the criteria, (b) second levels of influence comprising levels of influence of the plurality of engagements with respect to the sub-criteria of all the criteria, and (c) third levels of influence comprising levels of influence of the sub-criteria of all the criteria with respect to the plurality of engagements. The method also includes determining a selection order of the plurality of engagements based on the first, the second, and third levels of influence, wherein the selection order comprises priority values which are indicative of a level of realization of each of the plurality of engagements for the selection of the at least one engagement from the plurality of engagements.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the figures to reference like features and components. Some embodiments of systems and/or methods in accordance with embodiments of the present subject matter are now described, by way of example only, and with reference to the accompanying figures, in which:

FIG. 1 illustrates a method for engagement analytics, according to an embodiment of the present subject matter.

FIG. 2 illustrates an engagement analytics system, according to an embodiment of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DETAILED DESCRIPTION

The present subject matter relates to systems and methods for engagement analytics for a business for analyzing a plurality of business engagements between a client and a vendor. The business engagements hereinafter referred to as the engagements. Based on the engagement analytics, one or more engagements may be selected, from the plurality of engagements, for transformation, such that a level of realization as desirable by the client can be achieved with the selected engagement(s).

The engagements of a business portfolio are based on one or more business objectives or goals associated with a service and/or a product provided by the vendor to the client. Examples of the business objectives include, cost reduction, risk minimization, ensuring of quality, infrastructure utilization, and such. The engagements may be established and/or selected for transformation based on a variety of criteria which may have an influence on levels of performance, maturity, and realization of engagements. The criteria may be defined by people, such as stakeholder in the business, experienced professionals, management personnel who may be overseeing the business process, and such.

Conventionally, an engagement is selected for transformation by experienced professionals and/or management personnel through experience, intuition, and/or interactions between the client and the vendor. The conventional methodologies for the selection of an engagement involve no substantial quantitative analytical analysis of engagements with respect to the various criteria. The conventional methodologies, further, are not based on inter-relationships and inter-influences between the criteria for the selection of an engagement. With this, the engagement may be selected based on a few criteria in isolation, without considering any inter-relationship with other criteria. Also, the selected engagement may not be feasible for transformation, may not achieve a level of realization as per the client, and may lack maturity and performance. With the above mentioned limitations, the conventional methodologies for the selection of an engagement for transformation are not substantially efficient.

The present subject matter describes systems and method for engagement analytics for a business for selection of one of more engagements for transformation. The one or more engagements may be selected from a plurality of engagements between a vendor and a client, and an engagement may be selected for transformation for improving the level of realization for the engagement. The transformation of an engagement refers to changes in the operating model and the pricing model associated with the engagement.

The engagements are defined based on a business objective. Further, the selection of one or more engagements is influenced by a variety of criteria. Thus, for the selection of engagement, engagement selection criteria may be defined. The engagement selection criteria may include a plurality of criteria and a set of sub-criteria for each of the plurality of criteria, which may influence the selection of engagement. Examples of criteria include relationship maturity of engagement, scale and size of engagement, and such. Examples of sub-criteria in the relationship maturity of engagement criteria include age of engagement, relative maturity of engagement, and such. With the systems and methods of the present subject matter, inter-relationships and inter-influences between the criteria, the sub-criteria and the engagements are considered which facilitate in finding an order for selection of the engagements. The order for selection indicates an order of potential of achieving a level of realization by the engagements after the transformation, based on which one or more engagements may be selected, on a priority basis, for transformation.

The methodology, according to the present subject matter, followed for analysis of the plurality of engagements for the selection of engagement(s) therefrom, is based on identification of criteria, and identification of sub-criteria of each of the criteria, associated with the plurality of engagements. The criteria and the sub-criteria may be identified from a predefined set of engagement selection criteria defined by or obtained from experienced professionals, management personnel, stakeholders, domain knowledge, and such.

Based on the identification of the criteria and the sub-criteria, influencor sub-criteria and influencee sub-criteria are identified amongst the sub-criteria of all the criteria. The influencor sub-criterion is a sub-criterion which influences another sub-criterion. The influencee sub-criterion is a sub-criterion which is influenced by another sub-criterion. For example, in the relationship maturity of engagement criteria, the age of engagement sub-criterion influences the relationship maturity sub-criteria. Thus, for the relationship maturity of engagement criteria, the age of engagement is the influencor sub-criterion and the relationship maturity is the influencee sub-criteria. The influence of an influencor sub-criterion on an influencee sub-criterion may be relevant for selection of engagement for transformation. In an implementation, each of the influencor sub-criteria may influence one or more influencee sub-criteria. Further, in an implementation, the influencor sub-criteria and the influencee sub-criteria may belong to the same criterion or may belong to two different criteria.

Further, based on identification of influencor sub-criteria and the influencee sub-criteria, levels of influence of the influencor sub-criteria of each of the criteria with respect to the influencee sub-criteria of each of the criteria are estimated for the purpose of selection of engagement. The levels of influence of the influencor sub-criteria with respect to the influencee sub-criteria are hereinafter referred to as first levels of influence. The first levels of influence are indicative of order of relative importance or relative relevance of influences of the sub-criteria of one criterion on one or more sub-criteria of the same criterion and another criterion. In an implementation, the first levels of influence of the influencor sub-criteria of each of the criteria with respect to the influencee sub-criteria of each of the criteria may be estimated based on user responses or inputs having degrees of relationship for each pair of influencor and influencee sub-criteria in the context of the engagements and selection thereof, in accordance with the present subject matter.

In addition to the first levels of influence, levels of influence of the plurality of engagements with respect to the sub-criteria of all the criteria are estimated for the purpose of selection of engagement. The levels of influence of the plurality of engagements with respect to the sub-criteria are hereinafter referred to as second levels of influence. The second levels of influence are indicative of order of relative importance or relative relevance of influences of the plurality of engagements on the sub-criteria of all the criteria. In an implementation, the second levels of influence of the plurality of engagements with respect to the sub-criteria of each of the criteria may be estimated based on user responses or inputs having degrees of relationship of each pair of engagement and sub-criteria in the context of the engagements and selection thereof, in accordance with the present subject matter.

Further, in addition to the first and the second levels of influence, levels of influence of the sub-criteria of all the criteria with respect to the plurality of engagements are estimated for the purpose of selection of engagement. The levels of influence of the sub-criteria with respect to the plurality of engagements are hereinafter referred to as third levels of influence. The third levels of influence are indicative of order of relative importance or relative relevance of influences of the sub-criteria of all the criteria on the plurality of engagements. In an implementation, the third levels of influence of the sub-criteria of each of the criteria with respect to the plurality of engagements may be estimated based on user responses or inputs having degrees of relationship of each pair of sub-criteria and engagement in the context of the engagements and selection thereof, in accordance with the present subject matter.

In an implementation, the user responses or inputs having the degrees of relationship in the context of the engagements and selection thereof, as described above, may be obtained from one or more users including, but not restricting to, stakeholders, business experts, business managers, and such, who are overseeing the business process.

Based on the estimation of the first, the second and the third levels of influence, a selection order of the plurality of engagements is determined. The selection order includes priority values which are indicative of a level of realization of each of the plurality of engagements. The level of realization is the potential or future level of realization for each of the engagements. The one or more engagements may be selected, on a priority basis, for transformation based on the selection order, and particularly based on the priority values of the selection order. In an implementation, the one or more engagements with the higher priority values may be selected for transformation.

With the methodology of engagement analytics for selection of one or more engagements for transformation, in accordance with the present subject matter, inter-relationships and inter-influences between the criteria, the sub-criteria and the engagements are considered. This facilitates in finding and selecting at least one engagement based on their potential of achieving a level of realization after the transformation of that engagement is carried out. Thus, the methodology of the present subject matter is substantially more efficient and reliable in comparison to the conventional methodologies for the selection of engagement(s).

In an implementation, an analytic network process (ANP) model may be used for estimation of all levels of influences, as described above, and for determining the selection order from the levels of influences for the selection of engagement(s) based on the potential of realization of the engagement after the transformation. The ANP model allows for estimation of the levels of influences across the criteria, the sub-criteria, and the plurality of engagements, based on the user responses for degrees of relationships between the influencor and influencee sub-criteria and between the engagements and various sub-criteria. The concept of the ANP model and the procedure involved, for the purpose of estimation of levels of influence and determination of selection order, are known to a person skilled in the art.

The method and the system of the present subject matter may be implemented to analyze a plurality of engagements between the vendor and client for a service and/or product providing businesses. Examples of businesses include banking and finance, telecommunication, healthcare, retail, software solutions, manufacturing, and such. The services may include testing and quality assurance, application development and maintenance, production support, infrastructure maintenance, and such.

These and other advantages of the present subject matter would be described in greater detail in conjunction with the following figures. It should be noted that the description and figures merely illustrate the principles of the present subject matter.

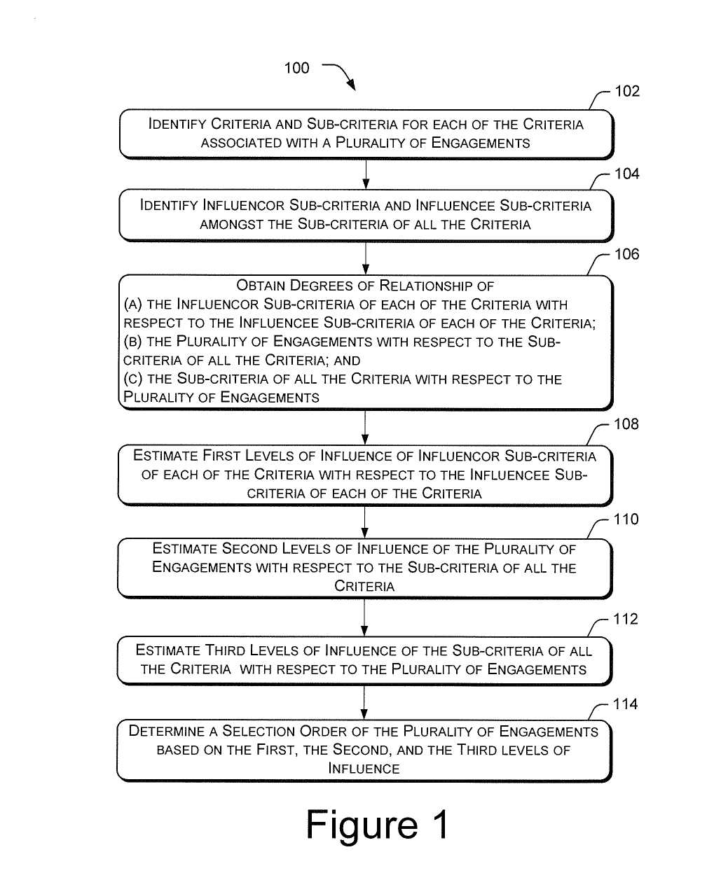

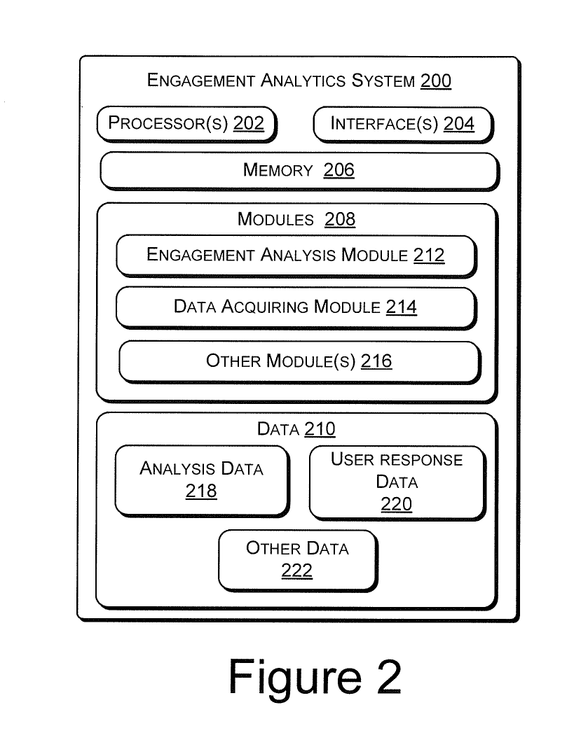

FIG. 1 illustrates a method 100 for engagement analytics, according to an embodiment of the present subject matter. The method 100 may be implemented in an engagement analytics system which is described later in the description with reference to FIG. 2.

The method 100 may be described in the general context of computer executable instructions. Generally, computer executable instructions can include routines, programs, objects, components, data structures, procedures, modules, and functions that perform particular functions or implement particular abstract data types. The method 100 may also be practiced in a distributed computing environment where functions are performed by remote processing devices that are linked through a communications network. In a distributed computing environment, computer executable instructions may be located in both local and remote computer storage media, including memory storage devices.

The order in which the method 100 is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the method 100 can be implemented in any suitable hardware, software, firmware, or combination thereof.

At block 102, criteria and sub-criteria of each of the criteria associated with a plurality of engagements are identified. The plurality of engagements may be based on a business objective or goal. The plurality of engagements includes engagements from which one or more engagements are to be selected for transformation, in accordance with the present subject matter. The criteria may be identified from a predefined set of criteria for the engagement selection, as mentioned earlier, and the sub-criteria may be identified from a predefined set of sub-criteria corresponding to each criterion for the engagement selection, as mentioned earlier.

In an implementation, the predefined set of criteria may include criteria, such as relationship maturity of engagement, scale and size of engagement, vendor leverage in engagement, technical complexity of operation, organizational maturity around operation, value realization from engagement, business criticality, and application maturity. It is understood that the above listed criteria are some examples of the possible criteria, and other criteria are also possible as may be defined by or obtained from experienced professionals, management personnel, stakeholders, domain knowledge, and such. Further, each of the criteria includes a set of sub-criteria for the selection of engagement(s). The sub-criteria of each of the criteria may be identified based predefined sets of sub-criteria corresponding to the criteria.

In an implementation, the sub-criteria for the relationship maturity of engagement criteria include, but not restricted to, the following:
age of engagement;
age of business portfolio;
relationship maturity; and
relative maturity of engagement.

In an implementation, the sub-criteria for the scale and size of engagement criteria include, but not restricted to, the following:
coverage of engagement;
engagement revenue;
engagement team size; and
user base.

In an implementation, the sub-criteria for the vendor leverage in engagement criteria include, but not restricted to, the following:
case of vendor consolidation;
distribution of vendor leverage;
number of vendors; and
ratio of client and vendor full-time equivalent.

In an implementation, the sub-criteria for the technical complexity of operation criteria include, but not restricted to, the following:
documentation around application;
domain competency requirements;
technical competency requirements;
technical complexity of tasks in operation; and
level of inter-task dependency.

In an implementation, the sub-criteria for the organizational maturity around operation criteria include, but not restricted to, the following:
efficiency of governance and communication;
project team competency;
vendor organizational competency; and
vendor process with respect to industry process.

In an implementation, the sub-criteria for the value realization from engagement criteria include, but not restricted to, the following:
efficiency;
enhancement;
business performance;
suitability of commercial model; and
suitability of operating model.

In an implementation, the sub-criteria for the business criticality criteria include, but not restricted to, the following:
criticality of engagement with respect to regulatory compliance;
dependence of other functions;
direct impact on business metrics;
direct impact on business image or market share; and
volume of users.

In an implementation, the sub-criteria for the application maturity criteria include, but not restricted to, the following:
fulfillment of functional requirements;
fulfillment of non-functional requirements;
number of versions; and
application up-time.

It is understood that the above listed sub-criteria for the abovementioned criteria are some examples of the possible sub-criteria, and other sub-criteria are also possible as may be defined by or obtained from experienced professionals, management personnel, stakeholders, domain knowledge, and such.

In an implementation, a multi-criteria decision making model is created for the identified criteria and the sub-criteria for the analysis of engagements for selection. The multi-criteria decision making model may be based on the ANP model. In the multi-criteria decision making model based on the ANP model, the criteria are identified as clusters, the sub-criteria are identified as nodes of the clusters, and the plurality of engagements, from which one or more engagements are to be selected, is identified as alternatives. The concept of clusters, nodes, and alternatives, in reference to the ANP model are known to a skillful person, and thus, for the sake of simplicity are not described herein.

Based on the identified criteria and sub-criteria, influencor sub-criteria and influencee sub-criteria are identified amongst the sub-criteria of all the criteria at block 104. For this, pairs of sub-criteria, amongst the same criteria and amongst different criteria, are identified, where in each pair one of the sub-criteria influences or is influenced by the other sub-criterion. The influence between each pair of sub-criteria is relevant for the selection of engagement(s) for transformation.

In an implementation, with reference to the clusters, the nodes and the alternatives created in the multi-criteria decision making model based on the ANP model, for the identification of the influencor and the influencee sub-criteria, each node (sub-criterion) of each cluster (criterion) is selected iteratively and nodes (sub-criteria) of each cluster (criterion) which are influenced by the selected node are identified. The nodes which are influenced are the influencee sub-criteria, and the nodes which are influencing are the influencor sub-criteria. Based on this identification, links between the influencing and the influenced nodes are created. The direction of link is from the influencing node to the influenced node. It may be understood that the pairs of nodes in which both the nodes influenced each other will have two-way links, and the pairs of nodes in which only one of nodes is influencing the other node will have one-way link. Further, since all the identified criteria and sub-criteria are associated with the plurality of engagements, in the multi-criteria decision making model based on the ANP model, all the clusters are linked to the alternatives having the engagements. In an example, the links between the clusters and the alternatives are two-way links as both influence each other for the selection of engagement(s) for transformation.

After identifying the influencor sub-criteria and the influencee sub-criteria, degrees of relationship of (a) the influencor sub-criteria of each of the criteria with respect to the influencee sub-criteria of each of the criteria, (b) the plurality of engagements with respect to the sub-criteria of all the criteria, and (c) the sub-criteria of all the criteria with respect to the plurality of engagements, are obtained at block 106. The degrees of relationship are obtained in the context of the engagements and the selection thereof. In an implementation, the degrees of relationship are obtained as user responses having answers to a questionnaire. The questionnaire is prepared based on the inter-relationships between the various sub-criteria of the criteria and based on the inter-relationships between the engagements and the sub-criteria of all the criteria, which have influence on the selection of engagements. Illustrations of questions in the questionnaire and the corresponding user responses are described in details further ahead in the specification.

In an implementation, with reference to various links created in the multi-criteria decision making model based on the ANP model, for obtaining the degrees of relationship of the influencor sub-criteria of each of the criteria with respect to the influencee sub-criteria of each of the criteria, each influenced node (influencee sub-criterion) of each cluster (criterion) is selected one-by-one and the degree of relationship of the one or more influencing nodes (influencor sub-criteria) with respect to the selected influenced node are obtained. The selection of influenced nodes and obtaining degrees of relationship may depend on the links created between the nodes. Further, the degrees of relationship are obtained against questions seeking answers based on one of impact, importance, relevance, influence, and such, which the influencing nodes have on the influenced nodes. Table 1 illustrates details of questions which may be framed for seeking user responses for the degrees of relationship of influencor sub-criteria represented in the influencing nodes on one influencee sub-criteria represented in the influenced node. Depending on the criteria and the sub-criteria of the criteria, questions may be framed for seeking user responses for one of impact, importance, relevance, influence, and such, which each of the influencor sub-criteria has on the influencee sub-criteria.

TABLE 1

| Question | User Response |
|---|---|
| What is the degree of relationship of influencor sub- | Answer 1 |
| criterion 1 on the influencee sub-criterion? | |
| What is the degree of relationship of influencor sub- | Answer 2 |
| criterion 2 on the influencee sub-criterion? | |
| What is the degree of relationship of influencor sub- | Answer 3 |
| criterion 3 on the influencee sub-criterion? | |

In an implementation, where two or more influencing nodes influence one influenced node, the degrees of relationship may be obtained against questions seeking answers based on one of relative impact, relative importance, relative relevance, relative influence, and such, which one influencing node has in comparison to another influencing node on the influenced node. Table 2 illustrates details of questions which may be framed for seeking user response for the degrees of relationship of one influencor sub-criterion in comparison to the other influencor sub-criterion on one influencee sub-criterion. Depending on the criteria and the sub-criteria of the criteria, questions may be framed for seeking user responses for one of relative impact, relative importance, relative relevance, relative influence, and such, which each of the influencor sub-criteria has in comparison to the other influencor sub-criteria on the influencee sub-criteria.

TABLE 2

| Question | User Response |
|---|---|
| What is the degree of relationship of influencor sub- | Answer 1 |
| criterion 1 in comparison to the influencor sub-criterion 2 | |
| on the influencee sub-criterion? | |
| What is the degree of relationship of influencor sub- | Answer 2 |
| criterion 1 in comparison to the influencor sub-criterion 3 | |
| on the influencee sub-criterion? | |
| What is the degree of relationship of influencor sub- | Answer 3 |
| criterion 2 in comparison to the influencor sub-criterion 3 | |
| on the influencee sub-criterion? | |

Similarly, with reference to the multi-criteria decision making model based on the ANP model, for obtaining the degrees of relationship of the engagements with respect to the sub-criteria of each of the criteria, each node (sub-criterion) of each cluster (criterion) is selected one-by-one and the degrees of relationship of the alternatives (engagements) with respect to the selected node are obtained. The degrees of relationship are obtained against questions seeking answers based on one of impact, importance, relevance, influence, and such, which the engagements have on the selected sub-criterion. Table 3 illustrates details of questions which may be framed for seeking user responses for the degrees of relationship of engagements represented in the alternatives on one sub-criterion represented in the selected node. Depending on the engagements and the sub-criteria of the criteria, questions may be framed for seeking user responses for one of impact, importance, relevance, influence, and such, which each of the engagements has on the sub-criterion.

TABLE 3

| Question | User Response |
|---|---|
| What is the degree of relationship of engagement 1 on | Answer 1 |
| the sub-criterion 1? | |
| What is the degree of relationship of engagement 2 on | Answer 2 |
| the sub-criterion 1? | |
| What is the degree of relationship of engagements 3 on | Answer 3 |
| the sub-criterion 1? | |

In an implementation, the degrees of relationship of the engagements with respect to the selected sub-criterion may be obtained against questions seeking answers based on one of relative impact, relative importance, relative relevance, relative influence, and such, which one engagement has in comparison to another engagement on the sub-criterion. Table 4 illustrates details of questions which may be framed for seeking user response for the degrees of relationship of one engagement in comparison to the other engagement on one sub-criterion. Depending on the engagements and the sub-criteria of the criteria, questions may be framed for seeking user responses for one of relative impact, relative importance, relative relevance, relative influence, and such, which each of the engagement has in comparison to the other engagement on the sub-criterion.

TABLE 4

| Question | User Response |
|---|---|
| What is the degree of relationship of engagement 1 in | Answer 1 |
| comparison to the engagement 2 on the sub-criterion 1? | |
| What is the degree of relationship of engagement 1 in | Answer 2 |
| comparison to the engagement 3 on the sub-criterion 1? | |
| What is the degree of relationship of engagement 2 in | Answer 3 |
| comparison to the engagement 3 on the sub-criterion 1? | |

Similarly, with reference to the multi-criteria decision making model based on the ANP model, for obtaining the degrees of relationship of the sub-criteria of all the criteria with respect to the engagements, each engagement in the alternatives is selected one-by-one and the degrees of relationship of the nodes (sub-criteria) with respect to the selected engagement are obtained. The degrees of relationship are obtained against questions seeking answers based on one of impact, importance, relevance, influence, and such, which the sub-criteria have on the selected engagement. Table 5 illustrates details of questions which may be framed for seeking user responses for the degrees of relationship of sub-criteria represented in the nodes on one engagement represented in the alternatives. Depending on the engagements and the sub-criteria of the criteria, questions may be framed for seeking user responses for one of impact, importance, relevance, influence, and such, which each of the sub-criteria has on the engagement.

TABLE 5

| Question | User Response |
|---|---|
| What is the degree of relationship of sub-criterion 1 on | Answer 1 |
| the engagement 1? | |
| What is the degree of relationship of sub-criterion 2 on | Answer 2 |
| the engagement 1? | |
| What is the degree of relationship of sub-criterion 3 on | Answer 3 |
| the engagement 1? | |

In an implementation, the degrees of relationship of the sub-criteria with respect to the selected engagement may be obtained against questions seeking answers based on one of relative impact, relative importance, relative relevance, relative influence, and such, which one sub-criterion has in comparison to another sub-criterion on the engagement. Table 6 illustrates details of questions which may be framed for seeking user response for the degrees of relationship of one sub-criterion in comparison to the other sub-criterion on one engagement. Depending on the engagements and the sub-criteria of the criteria, questions may be framed for seeking user responses for one of relative impact, relative importance, relative relevance, relative influence, and such, which each of the sub-criteria has in comparison to the other sub-criterion on the engagement.

TABLE 6

| Question | User Response |
|---|---|
| What is the degree of relationship of sub-criterion 1 in | Answer 1 |
| comparison to the sub-criterion 2 on the engagement? | |
| What is the degree of relationship of sub-criterion 1 in | Answer 2 |
| comparison to the sub-criterion 3 on the engagement? | |
| What is the degree of relationship of sub-criterion 2 in | Answer 3 |
| comparison to the sub-criterion 3 on the engagement? | |

In an implementation, the various user responses for the degree of relationship, as mentioned above in the description, may be in the form a numerical value depending on the question. The numerical value may be a factual value, or an indicative value based on a predefined scale. In an example, the predefined scale may include values from 1 to 9 in accordance with the ANP model.

In an implementation, the questionnaire may be prepared based on the criteria and the sub-criteria identified for the selection of engagement(s) for transformation. The questionnaire may include questions for obtaining degree of relationships of sub-criteria of all the criteria with respect to each other, for obtaining degree of relationship of sub-criteria of all the criteria with respect to the plurality of engagements, and for obtaining degree of relationship of the plurality of engagements with respect to the sub-criteria of all the criteria. In an implementation, the user responses of the degree of relationship may be obtained before the creation of the multi-criteria decision making model, and the degree of relationship based on the links created in the multi-criteria decision making model may be obtained for the purpose of analysis of engagements for the selection of engagement(s) for transformation. In an implementation, the user responses of the degree of relationships may be obtained, in real-time, based on the links created in the multi-criteria decision making model after the creation of the multi-criteria decision making model.

Further, at block 108, first levels of influence including levels of influence of the influencor sub-criteria of each of the criteria with respect to the influencee sub-criteria of each of the criteria are estimated. The first levels of influence are estimated based on the degrees of relationship of the influencor sub-criteria with respect to the influencee sub-criteria.

In an implementation, with reference to various degrees of relationship obtained in the multi-criteria decision making model based on the ANP model, for estimating the first levels of influence of the influencor sub-criteria of each of the criteria with respect to the influencee sub-criteria of each of the criteria, each influenced node (influencee sub-criterion) is selected one-by-one and, cluster-wise (criterion-wise), the first level of influence of the one or more influencing nodes (influencor sub-criteria) in each cluster with respect to the selected influenced node are estimated.

The description hereinafter describes the procedure for estimation of the first level of influence of the influencor sub-criteria of one criterion with respect to the influencee sub-criterion of one criterion. Same procedure is followed for estimating all the first levels of influence. For this, a pair-wise comparison matrix is created based on the corresponding degrees of relationship obtained as the user responses. The pair-wise comparison matrix is a square matrix of an order equal to the number of influencor sub-criteria influencing the influencee sub-criterion. Each cell of the pair-wise comparison matrix has a value corresponding to a relative degree of relationship between a pair of influencor sub-criteria with respect to the influencee sub-criterion. In an implementation, where the degrees of relationship for the impact, importance, relevance, or influence, which is direct and not relative, are obtained based on questions as illustrated in Table 1, the relative degree of relationship for each pair of influencor sub-criteria are determined by dividing the degree of relationship of one influencor sub-criterion by the degree of relationship of the other influencor sub-criterion. In reference to Table 1, the relative degree of relationship for influencor sub-criterion 1 with respect to the influencor sub-criterion 2 is Answer 1/Answer 2. And, the relative degree of relationship for influencor sub-criterion 2 with respect to the influencor sub-criterion 2 is Answer 2/Answer 1. Likewise relative degrees of relationship for all the pairs of influencor sub-criteria are determined to fill the cell of the pair-wise comparison matrix. In an implementation, where the degrees of relationship for the relative impact, relative importance, relative relevance, or relative influence are obtained based on questions as illustrated in Table 2, the relative degree of relationship for each pair of influencor sub-criteria are determined directly by the answers in the user responses and their reciprocals. In reference to Table 1, the relative degree of relationship for influencor sub-criterion 1 with respect to the influencor sub-criterion 2 is Answer 1. And, the relative degree of relationship for influencor sub-criterion 2 with respect to the influencor sub-criterion 2 is 1/Answer 1. Likewise relative degrees of relationship for all the pairs of influencor sub-criteria are determined to fill the cell of the pair-wise comparison matrix. The diagonal cells of the pair-wise comparison matrix have values of 1.

After creating the pair-wise comparison matrix, an eigen vector for the matrix is computed. The eigen vector corresponds to the first level of influence of the influencor sub-criteria of one criterion with respect to the influencee sub-criterion of one criterion. Each eigen value in the eigen vector corresponds to a level of influence of one of the influencor sub-criteria depending on the order of the influencor sub-criteria in the rows and columns of the pair-wise comparison matrix.

Further, at block 110, second levels of influence including levels of influence of the engagements with respect to the sub-criteria of all the criteria are estimated. The second levels of influence are estimated based on the degrees of relationship of the engagements with respect to the sub-criteria.

In an implementation, with reference to various degrees of relationship obtained in the multi-criteria decision making model based on the ANP model, for estimating the second levels of influence of the engagements with respect to the sub-criteria of each of the criteria, each node (sub-criterion) is selected one-by-one, and the second level of influence of the engagements in the alternatives are estimated with respect to the selected node. The second levels of influence are estimated in a similar manner as described for the estimation of the first levels of influence. For each sub-criterion, the pair-wise comparison matrix is a square matrix of an order equal to the number of engagements, where each cell of the pair-wise comparison matrix has a value corresponding to a relative degree of importance of an engagement between a pair of engagements with respect to the sub-criterion. The eigen vector determined corresponds to the second level of influence of the engagements with respect to the sub-criterion. Each eigen value in the eigen vector corresponds to a level of influence of one of the engagements depending on the order of the engagements in the rows and columns of the pair-wise comparison matrix.

Further, at block 112, third levels of influence including levels of influence of the sub-criteria of each of the criteria with respect to the engagements are estimated. The third levels of influence are estimated based on the degrees of relationship of the sub-criteria of each criterion with respect to engagements.

In an implementation, with reference to various degrees of relationship obtained in the multi-criteria decision making model based on the ANP model, for estimating the third levels of influence of the sub-criteria of each of the criteria with respect to the engagements, each engagement is selected one-by-one, and the third level of influence of the nodes (sub-criteria) in one cluster (criterion) are estimated with respect to the engagement. The third levels of influence are estimated in a similar manner as described for the estimation of the first levels of influence. For each engagement, the pair-wise comparison matrix is a square matrix of an order equal to the number of sub-criteria in a criterion, where each cell of the pair-wise comparison matrix has a value corresponding to a relative degree of relationship between a pair of sub-criteria with respect to the engagement. The eigen vector determined corresponds to the third level of influence of the sub-criteria with respect to the engagement. Each eigen value in the eigen vector corresponds to a level of influence of one of the sub-criteria depending on the order of the sub-criteria in the rows and columns of the pair-wise comparison matrix.

Further, in an implementation, the first, the second, and the third levels of influences are estimated by leveraging weight factors on the values of the eigen vectors as computed for all the criteria and engagements. The weight factors are indicative of degree of inter-relationship between all criteria, and between the criteria and the engagements. The weight factors are leveraged for considering the contribution of overall importance of criteria with respect to the other criteria, overall importance of criteria with respect to the engagements, and overall importance of engagements with respect to the criteria. For this, weight factors for each criterion with respect to other criteria, weight factors of engagements with respect to all the criteria, and weight factors of each criterion with respect to the engagements may be obtained from the user.

The weight factors may be obtained as user responses to questions framed for seeking answers to the degrees of inter-relationship based on the context of transformation of engagements. In an implementation, the weight factors may be obtained as numerical values based on a predefined scale. In an example, the predefined scale may include values from 1 to 9 in accordance with the ANP model.

In an implementation, with reference to various eigen vectors computed in the multi-criteria decision making model based on the ANP model, for leveraging the weight factors in each criterion with respect to all the criteria, the eigen vector for influencor sub-criteria with respect to each influencee sub-criterion is multiplied by the weight factor corresponding to the pair of criteria, and then normalized to 1. These eigen vectors leveraged by the weight factors are the first levels of influences. Similarly, for leveraging the weight factors in each criterion with respect to the engagements, the eigen vector for sub-criteria with respect to each engagement is multiplied by the weight factor corresponding to the pair of criterion and engagement, and then normalized to 1. These eigen vector leveraged by the weight factors are the second levels of influences. Similarly, for leveraging the weight factors in the engagements with respect to each criterion, the eigen vector for engagements with respect to each sub-criterion is multiplied by the weight factor corresponding to the pair of engagement and criterion, and then normalized to 1.These eigen vector leveraged by the weight factors are the third levels of influences.

Further, after the estimation of the first, the second, and the third levels of influence as described above, a selection order of the plurality of engagements is determined at block 114. The selection order is determined based on the first, the second, and the third levels of influences estimated as described above.

The description below describes the procedure to determine the selection order, in accordance with the implementation with reference to the multi-criteria decision making model based on the ANP model. For determining the selection order, a matrix is created, and the first, the second, and the third levels of influences are arranged in the matrix. The matrix is a square matrix of an order equal to the sum total of the number of engagements and the number of sub-criteria. Such matrix may be referred to as a super-matrix with reference to the ANP model. The plurality of engagements and all the sub-criteria, criterion-wise, are arranged in the rows and columns of the matrix. The creation of the matrix is in a manner of creation of the super-matrix in the ANP model, as known to a skillful person.

After the creation of the matrix, the matrix is iteratively raised to a high power or exponent till the values in each column of the matrix are same. The raising of the matrix implied the matrix is self-multiplied multiple times till the values in each column of the matrix are same. The same values in each column imply that each individual engagement and each individual sub-criterion of all the criteria influence each of the engagements and each of the sub-criteria with the same level or magnitude. Further, the same values in each column are achieved to reach a steady state influence levels between the sub-criteria and the engagements.

Based on the matrix raised to a high power, the selection order is determined by the values in the cells of rows, of the raised matrix, corresponding to the plurality of engagements. The selection order obtained in this manner has values indicative of a level of realization of each of the plurality of engagements if selected for transformation. Further, the values in the selection order facilitate the user to select one or more engagements for transformation, on a priority basis, based on the values corresponding to the engagements in the selection order. Thus, the values in the selection order are also understood as the priority values. In an implementation, the one or more engagements with higher priority values may selected, on the priority basis, for transformation.

In an implementation, the priority values in the selection order may be normalized to 1. The normalized values indicate levels of realization of the plurality of engagements in percentage.

Further, in an implementation, either the priority values in the selection order or the normalized values are divided by the highest priority value or the highest normalized value, respectively, to obtain ideal values. The ideal values facilitate in comparing the levels of realization of the engagements if the level of realization of the engagements with the highest priority value or the highest normalized value is 1, i.e., 100%.

FIG. 2 illustrates an engagement analytics system 200, according to an embodiment of the present subject matter. In an implementation, the engagement analytics system 200 implements the method 100 for analysis of plurality of engagements for transformation as described earlier in the description. The engagement analytics system 200 may be a software-based implementation or a hardware-based implementation or both. The engagement analytics system 200 may be implemented in a computing device, such as a server, a mainframe computer, a workstation, a personal computer, a desktop computer, a minicomputer, a server, a laptop, and a tablet; in a mobile communication device, such as a personal digital assistant, a smart phone, and a mobile phone; and the like.

In an implementation, the engagement analytics system 200 may communicatively coupled to a database (not shown) for the purpose of acquiring data and information related to the analysis of engagements in accordance with the present subject matter.

Further, in an implementation, a user may access the engagement analytics system 200 for analyzing a plurality of engagements for the purpose of selection of one or more engagements for transformation. For the purpose of description herein, the user may be understood as a professional who has skills and capability of analyzing engagements associated with a business. The user may include a stakeholder, a management personnel, a professional overseeing the business, and such. Further, the user may be an authentic user who is allowed to access the engagement analytics system 200. In an implementation, the user is provided with a user interface, such as a graphic user interface (GUI), which may be used for the purposes of analyzing the engagements of a business.

The engagement analytics system 200 includes one or more processor(s) 202, interface(s) 204, and a memory 206 coupled to the processor(s) 202. The processor 202 can be a single processor unit or a number of units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions and data stored in the memory 206.

Functions of the various elements shown in FIG. 2, including the functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, or by a plurality of sub-processors. Moreover, explicit use of the term “processor” should not be construed to refer exclusively to hardware capable of executing software, and may implicitly include, with a limitation, Digital Signal Processor (DSP) hardware, network processor, Application Specific Integrated Circuit (ASIC), Field Programmable Gate Array (FPGA), Read Only Memory (ROM) for storing software, Random Access Memory (RAM), and non-volatile storage. Other hardware, conventional or custom, may also be included. Further, the processor 202 may include various hardware components, such as adders, shifters, sign correctors, and generators required for executing various applications such as arithmetic operations.

The interface(s) 204 may include a variety of software and hardware interfaces, for example, interfaces for peripheral device(s), such as a keyboard, a mouse, an external memory, and a printer. The interface(s) 204 may enable the engagement analytics system 200 to communicate with other devices, such as external computing devices and external databases.

The memory 206 may include any computer-readable medium known in the art including, for example, volatile memory such as static random access memory (SRAM) and dynamic random access memory (DRAM), and/or non-volatile memory, such as read only memory (ROM), erasable programmable ROM, flash memories, hard disks, optical disks, and magnetic tapes.

Further, the engagement analytics system 200 includes module(s) 208 coupled to the processor 202, and includes data 210. The modules 208 include routines, programs, objects, components, data structures, and the like, which perform particular tasks or implement particular abstract data types. The modules 208 further include modules that supplement applications on the engagement analytics system 200, for example, modules of an operating system. The data 210, amongst other things, serves as a repository for storing data that may be processed, received, or generated by one or more of the modules 208.

In an implementation, the modules 208 of the engagement analytics system 200 include an engagement analysis module 212, a data acquiring mode 214, and other module(s) 216. The other module(s) 216 may include programs or coded instructions that supplement applications and function, for example, programs in the operating system of the engagement analytics system 200.

In an implementation, the data 210 include analysis data 218, user response 220, and other data 222. The other data 222 includes data generated as a result of the execution of one or more modules in the other module(s) 216.

At first, the user identifies a business and a plurality of engagements which are to be analyzed for the selection of one or more engagements for transformation with a desirable level of realization. The engagement analysis module 212 allows the user to list the plurality of engagements associated with the business. Based on the listed engagements, the engagement analysis module 212 identifies engagement selection criteria including criteria and sub-criteria for each of the criteria. The details of the criteria and the sub-criteria which may be identified for the engagement analysis are mentioned earlier in the description.

In an implementation, the user may manually feed in the details of the criteria and the sub-criteria for the engagement analysis. In an implementation, the details of the criteria and sub-criteria may be pre-stored in the engagement analytics system 200, and are identified by the engagement analysis module 212 for the engagement analysis. Further, in an implementation, the engagement analysis module 212 may communicate with an external data base for obtaining and identifying the criteria and the sub-criteria for the engagement analysis. The details of the identified criteria and the sub-criteria are stored in the analysis data 218.

Based on the identified criteria and the sub-criteria, the engagement analysis module 212 identifies influencor sub-criteria and influencee sub-criteria amongst the sub-criteria of all the criteria. The influencor sub-criteria and the influencee sub-criteria may be identified by the engagement analysis module 212 based on a predefined set or rules governed by the business and the plurality of engagements. Further, the influencor sub-criteria and the influencee sub-criteria may be identified by the engagement analysis module 212 based on selections by the user. The details of the influencor sub-criteria and the influencee sub-criteria are stored in the analysis data 218.

In an implementation, the engagement analysis module 212 may create a multi-criteria decision making model based on the ANP model for the plurality of engagements, the identified criteria and the sub-criteria. In the created model, various links between different criteria are created based on the identified influencor sub-criteria and the influencee sub-criteria. Links between the criteria and the engagements are also created on the model. The details of the creation of the multi-criteria decision making model, and the creation of various links in the model are described earlier in the description.

Further, the data acquiring module 214 is configured to obtain data related to degrees of relationship of (a) the influencor sub-criteria of each of the criteria with respect to the influencee sub-criteria of each of the criteria, (b) the plurality of engagements with respect to the sub-criteria of all the criteria, and (c) the sub-criteria of all the criteria with respect to the plurality of engagements. As mentioned earlier, the degrees of relationships are obtained as user responses including answers to questions. The details of various questions and the procedure of obtaining the answers having the degrees of relationships are described earlier in the description. The user responses having the degree of relationship may be in the form a numerical value depending on the question. The numerical value may be a factual value, or an indicative value based on a predefined scale. In an example, the predefined scale may include values from 1 to 9 in accordance with the ANP model. The data related to the degrees of relationship in the user responses is stored in the user response data 220.

In an implementation, the data acquiring module 214 may obtain the various degrees of relationships, as described above, in real-time, from the user. For this, the questions are provided to the user, and the user may manually input the responses with answers to the questions. In an implementation, the degrees of relationship may be pre-stored in the engagement analytics system 200 based on the user responses, and the data acquiring module 214 may obtain the various degrees of relationship thereof. In another implementation, the various degrees of relationship are stored in an external database, and the data acquiring module 214 may communicate with the external database for obtaining the degrees of relationship.

After obtaining the various degrees of relationship as described in the description herein, the engagement analysis module 212 estimates the first levels of influence including the levels of influence of the influencor sub-criteria of each of the criteria with respect to the influencee sub-criteria of each of the criteria are estimated. The engagement analysis module 212 estimates the first levels of influence based on the degrees of relationship of the influencor sub-criteria with respect to the influencee sub-criteria, in accordance with the procedure described in details earlier in the description with respect to the method 100. The estimated first levels of influence are stores in the analysis data 218.

The engagement analysis module 212 also estimates the second levels of influence including levels of influence of the engagements with respect to the sub-criteria of all the criteria, and estimates the third levels of influence including levels of influence of the sub-criteria of each of the criteria with respect to the engagements. The engagement analysis module 212 estimates the second and the third levels of influence based on the degrees of relationship of the engagements with respect to the sub-criteria and based on the degrees of relationship of the sub-criteria of each criterion with respect to engagements, respectively. The estimations of the second and the third levels of influence are in a manner similar for the estimation of the first levels of influence. The estimated second and the third levels of influence are stores in the analysis data 218.

Further, in an implementation, the engagement analysis module 212 leverages the weight factors between all the criteria, and between the criteria and the engagements, for estimating the first, the second, and the third levels of influence, as described earlier in the description. The data acquiring module 214 is configured to obtain the various weight factors, which are used by the engagement analysis module 212 for the estimation of the levels of influence. In an implementation, the weight factors may be obtained from the user in real-time, or prior to performing the analysis of engagements in accordance with the present subject matter. The data related to the weight factors is stored in the user response data 220.

Further, based on the first, the second, and the third levels of influence, the engagement analysis module 212 determines a selection order of the plurality of engagements, which includes priority values indicative of a level of realization of each of the plurality of engagements if selected for transformation. The priority values in the selection order facilitates the user to identify which engagement(s) has a potential to achieve a desirable level of realization and can be selected for transformation. For determining the selection order, the engagement analysis module 212 follows the procedure as described in details earlier in the description with reference to the ANP model. The data related to the determined selection order is stored in the analysis data 218.

Although embodiments for the method and system for engagement analytics have been described in language specific to structural features, it is to be understood that the invention is not necessarily limited to the specific features described. Rather, the specific features are disclosed and explained in the context of a few embodiments for the method and system.

Other advantages of the method and system of the present subject matter will become better understood from the description and claims of an exemplary embodiment of the method and system. The method and system of the present subject matter are not restricted to the embodiments that are mentioned above in the description.

Although the subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter. It is therefore contemplated that such modifications can be made without departing from the spirit or scope of the present subject matter as defined.

I/we claim:

1. A computer implemented method for engagement analytics, the method comprising:
identifying criteria, and sub-criteria of each of the criteria, associated with a plurality of engagements between a vendor and a client, wherein the plurality of engagements is based on a business objective;
identifying influencor sub-criteria and influencee sub-criteria amongst the sub-criteria of all the criteria, wherein each of the influencor sub-criteria has an influence, relevant for selection of at least one engagement, on at least one of the influencee sub-criteria;
estimating,
first levels of influence comprising levels of influence of the influencor sub-criteria of each of the criteria with respect to the influencee sub-criteria of each of the criteria;
second levels of influence comprising levels of influence of the plurality of engagements with respect to the sub-criteria of all the criteria; and
third levels of influence comprising levels of influence of the sub-criteria of all the criteria with respect to the plurality of engagements; and
determining a selection order of the plurality of engagements based on the first, the second, and the third levels of influence, wherein the selection order comprises priority values which are indicative of a level of realization of each of the plurality of engagements for the selection of the at least one engagement from the plurality of engagements.

2. The method as claimed in claim 1, wherein the estimating the first levels of influence is based on degrees of relationship indicative of one of importance, impact, relevance, and influence of the influencor sub-criteria with respect to the influencee sub-criteria in context of the plurality of engagements.

3. The method as claimed in claim 1, wherein the estimating the second levels of influence is based on degrees of relationship indicative of one of importance, impact, relevance, and influence of the plurality of engagements with respect to the sub-criteria in context of the plurality of engagements.

4. The method as claimed in claim 1, wherein the estimating the third levels of influence is based on degrees of relationship indicative of one of importance, impact, relevance, and influence of the sub-criteria with respect to the plurality of engagements in context of the plurality of engagements.

5. The method as claimed in claim 2 further comprising obtaining the degrees of relationship in the form of user responses to questionnaire based on the criteria and the sub-criteria.

6. The method as claimed in claim 1, wherein the first, the second, and the third levels of influence are estimated, and the selection order is determined, through an analytic network process (ANP) model using user responses comprising degrees of relationship between the influencor sub-criteria and the influencee sub-criteria and between the engagements and the sub-criteria.

7. The method as claimed in claim 1, wherein the influencor sub-criteria and the influencee sub-criteria are amongst the sub-criteria of a same criterion.

8. The method as claimed in claim 1, wherein the influencor sub-criteria and the influencee sub-criteria are amongst the sub-criteria of different criteria.

9. The method as claimed in claim 1, wherein the criteria comprise relationship maturity of engagement, scale and size of engagement, vendor leverage in engagement, technical complexity of function, organizational maturity around function, value realization from engagement, business criticality, and application maturity.

10. An engagement analytics system comprising:
a processor;
an engagement analysis module coupled to the processor, the engagement analysis module is configured to,
identify criteria, and sub-criteria of each of the criteria, associated with a plurality of engagements between a vendor and a client, wherein the plurality of engagements is based on a business objective;
identify influencor sub-criteria and influencee sub-criteria amongst the sub-criteria of all the criteria, wherein each of the influencor sub-criteria has an influence, relevant for selection of at least one engagement, on at least one of the influencee sub-criteria;
estimate,
first levels of influence comprising levels of influence of the influencor sub-criteria of each of the criteria with respect to the influencee sub-criteria of each of the criteria;
second levels of influence comprising levels of influence of the plurality of engagements with respect to the sub-criteria of all the criteria; and
third levels of influence comprising levels of influence of the sub-criteria of all the criteria with respect to the plurality of engagements; and
determine a selection order of the plurality of engagements based on the first, the second, and the third levels of influence, wherein the selection order comprises priority values which are indicative of a level of realization of each of the plurality of engagements for the selection of the at least one engagement from the plurality of engagements.

11. The engagement analytics system as claimed in claim 10, wherein the engagement analysis module is configured to estimate the first levels of influence based on degrees of relationship indicative of one of importance, impact, relevance, and influence of the influencor sub-criteria with respect to the influencee sub-criteria in context of the plurality of engagements.

12. The engagement analytics system as claimed in claim 10, wherein the engagement analysis module is configured to estimate the second levels of influence based on degrees of relationship indicative of one of importance, impact, relevance, and influence of the plurality of engagements with respect to the sub-criteria in context of the plurality of engagements.

13. The engagement analytics system as claimed in claim 10, wherein the engagement analysis module is configured to estimate the third levels of influence is based on degrees of relationship indicative of one of importance, impact, relevance, and influence of the sub-criteria with respect to the plurality of engagements in context of the plurality of engagements.

14. The engagement analytics system as claimed in claim 11 further comprising a data acquiring module coupled to the processor, the data acquiring module is configured to obtain the degrees of relationship, wherein the degrees of relationship are in the form of user responses to questionnaire based on the criteria and the sub-criteria.

15. The engagement analytics system as claimed in claim 10, wherein the influencor sub-criteria and the influencee sub-criteria are amongst the sub-criteria of a same criterion.

16. The engagement analytics system as claimed in claim 10, wherein the influencor sub-criteria and the influencee sub-criteria are amongst the sub-criteria of different criteria.

17. A non-transitory computer-readable medium having computer-executable instructions that when executed perform acts comprising:
identifying criteria, and sub-criteria of each of the criteria, associated with a plurality of engagements between a vendor and a client, wherein the plurality of engagements is based on a business objective;
identifying influencor sub-criteria and influencee sub-criteria amongst the sub-criteria of all the criteria, wherein each of the influencor sub-criteria has an influence, relevant for selection of at least one engagement, on at least one of the influencee sub-criteria;
estimating,
first levels of influence comprising levels of influence of the influencor sub-criteria of each of the criteria with respect to the influencee sub-criteria of each of the criteria;
second levels of influence comprising levels of influence of the plurality of engagements with respect to the sub-criteria of all the criteria; and
third levels of influence comprising levels of influence of the sub-criteria of all the criteria with respect to the plurality of engagements; and
determining a selection order of the plurality of engagements based on the first, the second, and the third levels of influence, wherein the selection order comprises priority values which are indicative of a level of realization of each of the plurality of engagements for the selection of the at least one engagement from the plurality of engagements.
